(19) United States
(12) Patent Application Publication
(10) Pub. No.: US 2011/0131876 A1
(43) Pub. Date: Jun. 9, 2011

(54) Combined Vertical Farm, Biofuel, Biomass, and Electric Power Generation Process and Facility

(75) Inventor: Glen James Pettibone, Concord, CA (US)

(73) Assignees: Glen James Pettibone, Concord, CA (US); Camilo Santana Saab, San Francisco, CA (US)

(21) Appl. No.: 12/948,779

(22) Filed: Nov. 18, 2010

Related U.S. Application Data
(60) Provisional application No. 61/263,378, filed on Nov. 22, 2009.

(51) Int. Cl. A01G 9/02; A01D 46/00; A01G 1/00; F23G 5/00

(52) U.S. Cl. 47/65; 47/83; 56/1; 47/58.1 LS; 110/255

(57) ABSTRACT

Methods and associated apparatus for automatically growing agricultural crops vertically and/or in a continuous fashion throughout each year (Vertical Farm) in combination with contiguous and co-located production of biofuel, food, biomass for the purpose of carbon sequestering (carbon credits), and biomass electric power generation. A process that incorporates vast arrays of continuous-loop conveyors, towering upon vertical framework, which allow potted plants to be transported throughout all stages of maturity in a manner which substantially multiplies yield per acre, allows production to proceed in both natural and artificial light, allows production and harvesting to be automated, and allows production to proceed in conditions which are highly favorable to plants but unfavorable to humans. The entire apparatus can be constructed of lightweight, cost-effective materials which afford mass-production and mass-array into vast automatic growing operations.

### 1. BACKGROUND OF THE INVENTION

A. Field of the Invention

The present invention relates to methods and associated apparatus for automatically growing agricultural crops vertically and/or in a continuous fashion throughout each year (Vertical Farm) in combination with contiguous and co-located production of biofuel, food, biomass for the purpose of carbon sequestering (carbon credits), and biomass electric power generation. Bottoming cycles such as Organic Rankine Cycles or geothermal cooling are added to this combination to scavenge the final waste heat and moisture between the waste discharge and ambient temperature, converting said temperature difference into additional useful energy and recovering moisture and other precipitates for recirculation. The process is carried out substantially in a closed system such that waste heat, waste moisture, and exhausts including but not limited to such constituents as carbon dioxide, ash, and reactive nitrogen are almost entirely reused.

B. Description of Prior Art

The invention is well suited for the cost effective production of food, biofuel, biomass, and electricity. The invention has the advantage of a manifold reduction in required space, water, nutrients, and time for production. The present invention also accomplishes its claims with optimum economy for constructions costs. Since the invention is constructed indoors in a greenhouse setting or in individual enclosures and is supplied with its own soils, it is not dependent on location, soil conditions, water availability, weather, season, or length of day. It can be operated in the presence not only of sunlight, but can operate in the presence or with the addition of artificially powered light sources driven by any external power source provided.

Taken individually from the prior art, each of the constituent processes of the invention (farming, processing, reforming, power generation) typically lose two-thirds of their input energy as waste versus useful work or products, and individually they fail to recover any of the chemical energy from by-products such as carbon dioxide. Taken individually, the constituent processes all contribute substantially to pollution, global warming, human disease, and international conflict to name a few of their inherent drawbacks. The invention describes a clear art and process which combines all of these constituent processes into one and effectively creates a kind of process flywheel, which can be driven in part by solar insolation and/or by any other external power sources such as wind, geothermal, ocean wave energy, hydro-electric, ocean hydroelectric, solar, biomass power, nuclear fission, nuclear fusion, or fossil fuels, and which recovers the heat, moisture, and chemical energy normally lost from the processes of prior art.

There is a need at present for the large scale production of food and biomass both to supply emerging food and energy markets and to offset impacts to food supplies and land usage created by the increasing usage of traditional food sources as fuel and the increasing global population placing pressures on food, water, fuel stocks, power generation, land and other resources. Prior inventions had addressed portions of the needs for automated or high-density production of crops for food and biomass, but had not addressed the optimal characteristics and symbiotic processes claimed here.

Previous inventions failed to address a vertical arrangement for growing plants and crops in a continuous fashion during the whole growing cycle, allowing seedling, immature, and mature plants to occupy portions of the growing apparatus at the same time and to arrange them in such a way as to optimize space resource utilization and light permeation through the canopy. U.S. Pat. No., 4,216,617 (4,216,617) failed to articulate a truly continuous loop in that an operator would periodically have to replace top and bottom portions of the described vertical apparatus and also failed thereby to produce a continuous automatable system. Also, U.S. Pat. No. 4,216,617 failed to address where the vegetation of most crops would propagate within the described arrangement; no space was afforded in the design for vegetation to achieve an appreciable height. In order to substantially increase the production of food and biomass, there is a need to fully automate farm production, as well as to produce crops on optimized vertical structures. In addition to increasing the speed of production, increasing the speed of harvest, and reducing labor and materials costs, full automation will allow the growth of plants in conditions which are optimal for plants but could be detrimental to human farmers, such as elevated carbon dioxide, lighting, temperature, nutrient chemicals, humidity, and depleted oxygen. Human farmers could not survive these conditions and so there is a need to configure automatic or robotic farming facilities which can take advantage of the highest crop density afforded by a vertical arrangement. A portion of this patent incorporates a vertical growing apparatus design which addresses these needs by way of example, and which has been fully described in a separate patent application by this same author.

Previous inventions which have sought to automate the productions of crops focused on certain vegetables and didn't address the growing characteristics of perennial grasses and canes such as corn, sorghum, switch-grass, and sugar cane which are key agronomic crops, as well as other similar crops. U.S. Pat. No. 6,508,033 (6,508,033) generalized a three axis and multi-zone robotic arrangement for cultivation but failed to address an optimum arrangement for these perennial grasses in that it failed to address the geometric advantage posed by perennial crops and failed to depict the preferred arrangement for automatically harvesting and replanting these crops, and other similar crops. U.S. Pat. No. 6,508,033 failed to address an arrangement that would allow for adaptability to the application of soil, hydroponic, or aeroponic growing schemes. U.S. Pat. No. 6,508,033 failed to achieve the closest arrangement for plants during all phases of growth. U.S. Pat. No. 6,508,033 sequenced seedlings on a planar conveyance with a fixed ceiling height suitable for mature plants such that the over head space above the seedlings (the difference in height between mature plants and seedlings) was not utilized. U.S. Pat. No. 6,508,033 was also more adapted for the production of annuals only, in that each time a plant was harvested it was completely replanted. Perennial grasses and other similar crops can be clipped at the end of a full growth cycle, leaving the roots intact and will re-grow new shoots which can be harvested at the end of the next growing cycle. There is a need for a system that allows re-harvesting of perennials and other similar crops. U.S. Pat. No. 6,508,033 arranged the plants in groups of many plants at the same stage of growth which would have the effect of increasing in-process inventory and therefore tie-up working capital. Whereas U.S. Pat. No. 6,508,033 described a multi-story vertical platform arrangement, it in effect was describing an expensive construction methodology which for many crops would prove not to be cost effective and would force an extensive use of artificial light to reach interior spaces between levels. Rather than a multi-story, frame-floor-and-ceiling approach, a towered framework approach is indicated which mimics other, proven natural forms for the maximum permeation and photosynthetic absorption of light such as the geometry of a pine forest or a tropical rainforest canopy. A design is needed for a towered framework to elevate and convey crops in a geometry which allows enough free space and porosity for natural and artificial light to filter through and scatter from floor to ceiling and wall-to-wall. Equally, a design is needed that is based on the absolute minimization of construction materials, such as a towered conveyance upon light-gauge framework rather than material intensive traditional structural design. Safety factors and practices for human occupancy are unnecessary for the sole occupancy of plants. Both the structure and the conveyance of U.S. Pat. No. 6,508,033 were material intensive, making the design not cost effective. A portion of this patent incorporates a vertical growing apparatus design which addresses these needs, by way of example, which has been fully described in a separate patent application by this same author.

Previous patent applications anticipated the use of a recirculative relationship between biomass power generation and biomass production (farming), but failed to anticipate the application to C4 perennial crops such as corn, sorghum, switch-grass and sugar cane, and other similar crops, failed to depict any reduction to practice for said designs, and failed to anticipate or exploit certain benefits. US Patent Application 20040129188kj depicted and briefly explained a similar process to this invention for recirculating waste streams from power generation back to agricultural operations growing plankton but totally failed to describe how this would be accomplished, as if it was obvious. The application did not anticipate the combination of such a recirculative cycle with a Vertical Farming operation, nor did it anticipate the incorporation of waste recoveries from milling, processing, distillation, and reforming. US Patent Application 20040129188kj did not anticipate the automation of the entire process in order to facilitate conditions inhospitable to humans but ideal for plants which also realizes peak efficiencies for production and which allows for artificial selection of peak performing plant individuals. US Patent Application 20040129188kj did not anticipate the incorporation of a greenhouse or enclosure to facilitate efficient recirculation of waste streams. US Patent Application 20040129188kj failed to anticipate the benefit of depleted oxygen farming, having overlooked the increase in photosynthetic rate due to the depletion of reaction products. US Patent Application 20040129188kj failed to anticipate the benefits of increased temperature and humidity provided by recirculated waste heat and moisture, lending to the production of tropical C4 crops such as sugar cane, and taking advantage of the documented behavior of plant stomata to contract in elevated carbon dioxide, retaining water, and in turn surviving higher temperatures which in turn results in higher photosynthetic reaction rates. US Patent Application 20040129188kj also proposes plankton as a preferred embodiment, whereas carbon dioxide enrichment concentrations are limited by aqueous solubility per Henry's Law as compared to this patent wherein carbon dioxide concentrations are not bounded.

### 2. SUMMARY OF THE INVENTION

The process flow (FIG. 1) of the invention begins with the production of plants in vast arrays of continuous conveyance loops (FIGS. 2, 3, and 4) which can be fashioned in such a way as to transport each plant in the closest possible proximity to one another and thus approximate the same planar distribution of plants normally associated with the unit ground space while gaining a multiplicative advantage in productivity as a result of multiple tiers of plants circulating from the ground up and back down vertical towers (FIG. 3, 11). Plants can be produced at regular intervals such as each minute, hour, day, week, or month depending on the particular species' growth versus time, the number of total plants in the tower, the height of the tower, and the rate at which the conveyance loops are indexed. This vertical growing apparatus, “Modular Vertical Farm Cell” (MVFC) has been fully described in a separate patent application by the same author of this invention.

After cultivation and maturation, the plants are harvested at fixed locations by conventional industrial robots travelling on automated rail or cable-guided trolleys. After harvesting, the biomass is transported via networks of conveyors to a central location for milling, fermentation, and distillation into biofuels. At this stage it is also optional that the biomass be milled or processed into food or feed.

Waste products from farming, milling, fermentation, and distillation, comprised generally of leftover biomass are then either reformed into more biofuel, burned in a Rankine power cycle to produce electricity, or buried or converted to durable consumer goods to the end of sequestering carbon from the atmosphere and the accompanying end of reversing or controlling global warming. The burial option can have the added purposes of providing high-quality topsoil and landfill.

The waste products of the combustion processes (reforming, electric generation) comprised generally of heat, moisture, carbon dioxide, mineral ash, and reactive nitrogen are then recycled back to the Vertical Farm. The compact nature of the Vertical Farming operation allows even distribution of these waste products, with minimal losses.

Because the entire operation is automated and enclosed, it can be operated in conditions inhospitable to human occupancy and yet remarkably optimal for the cultivation of plants. The scientific literature supports that the Vertical Farm will experience greatly enhanced growing characteristics as a result of elevated carbon dioxide, decreased oxygen, supplemental light, extended growing day, elevated temperature coinciding with elevated moisture and carbon dioxide, and optimal soil conditions. These same conditions make the operation inhospitable to pests and some microbes, lending to reductions or eliminations in required pesticides and fungicides and, in some cases, the production of organic food, fuel, power, and biomass. Automation also provides the opportunity for artificial intelligence-based selection of highest-yielding individuals for re-planting, leading to generation after generation of improvement.

Enclosing the operation in a greenhouse environment affords protection from adverse weather and environmental conditions making the production secure and predictable. Such enclosure also affords the optimal distribution of waste heat, moisture, carbon dioxide, mineral ash, and reactive nitrogen and the coinciding recovery of the maximum amount of said waste products.

### 3. BRIEF DESCRIPTION OF THE DRAWINGS

A fuller understanding of the nature and objects of the present invention will become apparent upon consideration of the following detailed description, taken in connection with the accompanying drawings, wherein:

FIG. 1 shows the process diagram for the invention.

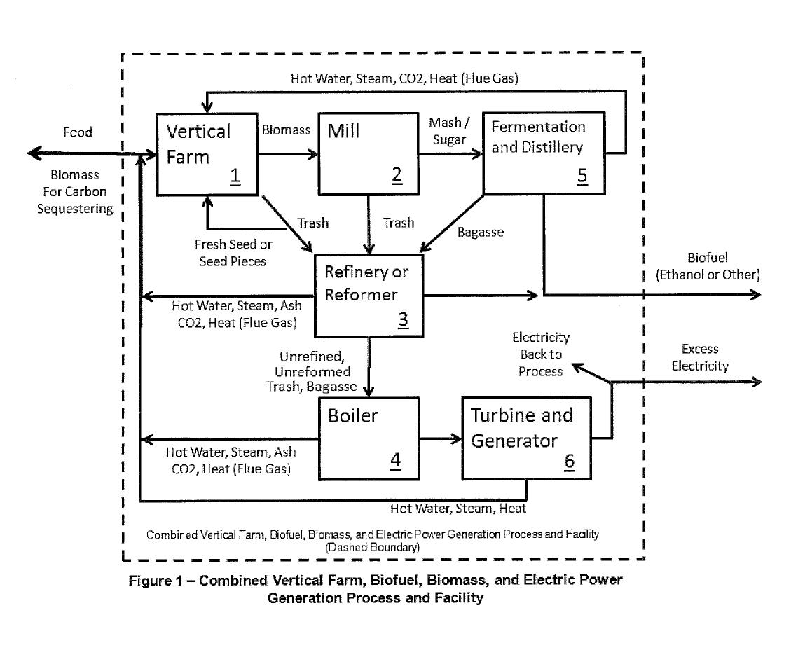

FIG. 2 shows in plan view an exemplar embodiment of one vertical farm acre, a plurality of which is embodied within item 1 on the process diagram depicted in FIG. 1. FIG. 2 also shows an enlarged plan view labeled “Detail A” comprised of a plurality of individual “Modular Vertical Farm Cells” (MVFC's) and representing a portion of the extensive array of the same depicted in FIGS. 2 and 3. Shaded portions of FIG. 2 depict chases in the foundation of said vertical farm used as aqueducts, exhaust ducts, and ventilated service tunnels.

FIG. 3 shows an elevation section view of a portion of the exemplar depicted in FIG. 2. Dotted leaders from both sides are intended to indicate that the section depicted in FIG. 3 is repeated sequentially throughout the Vertical Farm.

FIG. 4 shows in plan view one exemplar embodiment of an entire, hypothetical Combined Vertical Farm, Biofuel, Biomass, and Electric Power Generation Process and Facility and shows an extensive array of acreages as depicted in FIG. 2.

### 4. DETAILED DESCRIPTION OF THE INVENTION

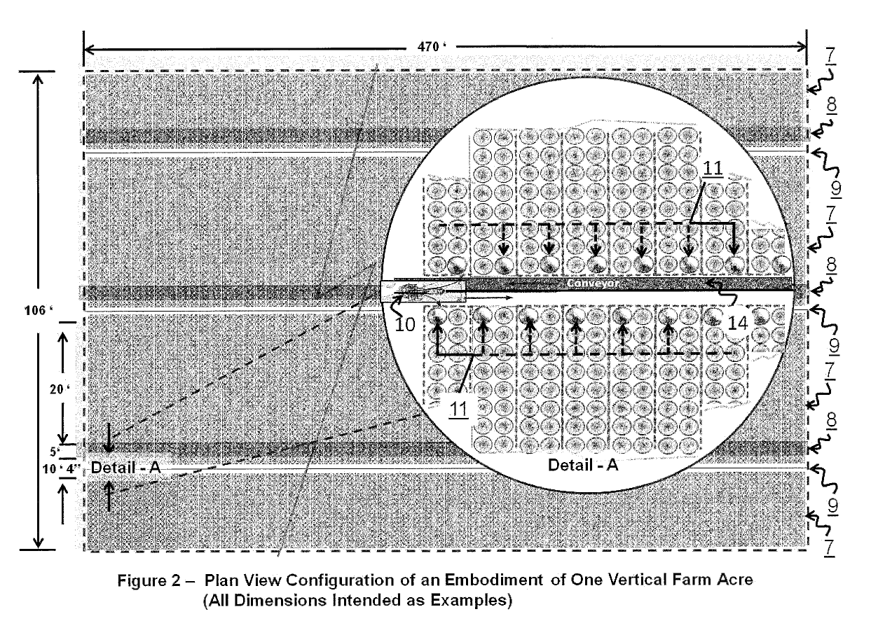

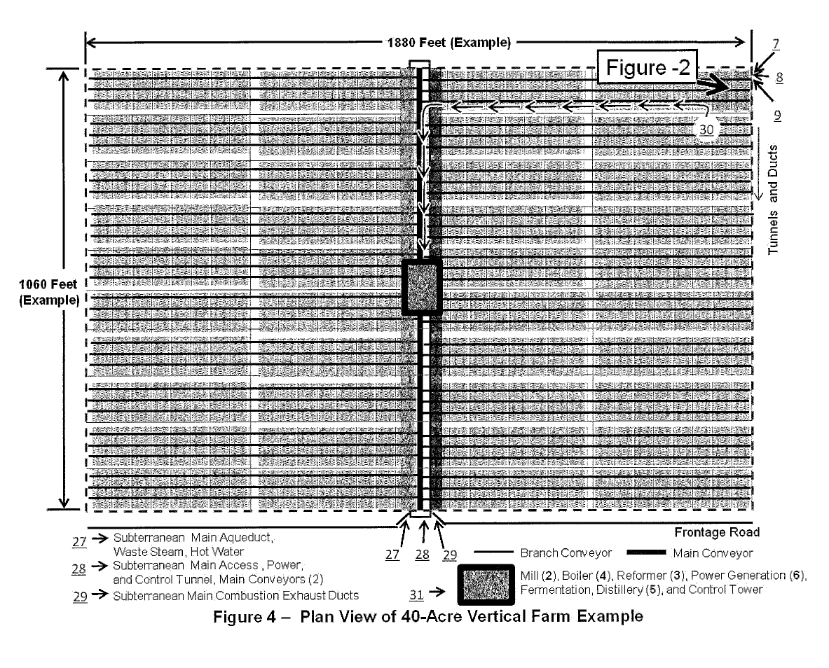

In one embodiment, C4 perennial crops such as corn, sorghum, or sugar cane are grown in high-volume, just-in-time, optimized, year-round, and continuous conditions in a Vertical Farm (1, and FIGS. 2, 3, and 4) housed in a greenhouse (21) as described below. Artificial lighting (22) is provided in order to supplement natural lighting. The foundation or hull (26) of the Vertical Farm (1) may be constructed on land, as a floating platform, or a plurality of platforms. From the Vertical Farm (1), harvested crops are sent for milling (2) or other processing to produce stock for mash. The sugars in the mash are fermented and then distilled in the Fermentation and Distillation (5) process into neat ethanol or other biofuel. Cellulosic material leftover after fermentation of sugars from the mash, or bagasse is dried and combined with organic trash from the Vertical Farm (1) and the Milling (2) operations. This combined organic, predominantly cellulosic material is sent either to a Reformer (3) where it is converted to additional biofuel or to the combustor of a Boiler (4) where steam is produced and electric power is generated by a Turbine (6) from this steam in a Rankine cycle. Optionally, harvested crops may be sent directly from the Vertical Farm (1) and Milling (2) operations for consumption as food or for sequestering of carbon, such as through burial of the bulk solid and liquid materials.

The waste products from the Mill (2), Fermentation and Distillery (5), Reformer (3), Boiler (4), and Turbine (6) include waste heat from the conditioned space where occupancy and combustion air are needed to run the processes and to facilitate occupancy, heat and moisture from hot combustion exhaust gases, carbon dioxide, steam (for example from blow-down), hot water condensed in the turbine and related condenser, reactive nitrogen compounds, and mineral-rich ash. All of these items are recycled to the Vertical Farm (1).

From the combustion exhaust stream, ash is separated by the usual means that may include either bag-filters, electrostatic precipitation, or both. This ash is rich in mineral nutrients and when mixed with soil serves as excellent fertilizer for the next generation of potted plants in the Vertical Farm (1). After removal of the ash, carbon monoxide is either further combusted from the exhaust gas stream or it is catalytically reacted and the waste heat is recovered. Optionally, reactive nitrogen is then reacted with ammonia to precipitate ammonium nitrate for additional plant fertilizer. The final combustion gas product, rich in carbon dioxide and moisture, and deficient in oxygen is blown by induced-draft or other fans into a network of large Exhaust Ducts (8) in the foundation or hull (26) of the Vertical Farm (1). These exhaust gases are blown from the Exhaust Ducts (8) through diffusers (20) that bubble the exhaust through the irrigation, cooling, and condenser water (15) stored in a network of aqueducts (7) running beneath vast arrays of MVFC's (11). The exhaust gases heat the water (15), and the heat radiates upward to warm the greenhouse (21). This heating combined with the bubbling action serve to humidify the greenhouse (21). During the bubbling diffusion (20), leftover ammonia and ammonium nitrate become dissolved and entrained in the water (15) and provide liquid nutrients to the plants during irrigation. This dissolved ammonia also serves to neutralize carbonic acid, allowing more carbon dioxide to be released into the greenhouse (21).

After diffusion (20), the remaining gases, rich in carbon dioxide and moisture, and deficient in oxygen, enter the greenhouse (21) at positive pressure relative to the atmospheric pressure outside the greenhouse (21). This positive pressure displaces the infiltration of nitrogen and oxygen into the greenhouse (21), and therefore sustains high concentrations of carbon dioxide gas and low concentrations of oxygen and nitrogen gas. The positive pressure, elevated carbon dioxide, and oxygen deficiency also serve to purge or thwart the infiltration of pests, microbes, and external pollutants. As a result of the diffusion process (20), plants in the Vertical Farm (1) are provided every advantage for photosynthesis, including elevated carbon dioxide, elevated moisture, elevated temperature, decreased oxygen and gaseous nitrogen, fertilizer and nutrients.

The Aqueducts (7) collect rainwater from the roof of the greenhouse (21) and condensation from the greenhouse exhausts and shell, and can be supplemented with water from any other conventional irrigation source, including for example well, river, lake, storm-water runoff, or treated wastewater. The water (15) is used as coolant for the condenser of the turbine, as irrigation for the Vertical Farm (1), as solvent for the diffusion process (20), as a humidity source for the greenhouse (21) environment, and as a radiant heating or cooling source for the greenhouse (21) environment. Scrapers can be fitted on drag chains in the Aqueducts (7) to harvest algae from the walls and bottom for use as additional biomass. When ambient temperatures outside the greenhouse (21), such as above 95 degrees Fahrenheit for typical sugar cane varieties for example, cooling for the Vertical Farm can be accomplished by circulating the water (15) through buried geothermal heat exchange coils or through the heat exchanger of an Organic Rankine Cycle (ORC). The ORC can in turn generate electricity to power supplemental lighting for the Vertical Farm (1). If needed, depending on the outside temperature, further cooling can be accomplished by pumping the water (15) through mist nozzles at the top of the greenhouse (21).

Service Tunnels (9) are fresh-air ventilated (16) by induced draft fans at the ends of the tunnels located at the perimeter of the Vertical Farm (1). The ventilation air is blown by the induced draft fans from the Vertical Farm (1) outside perimeter towards the center of the Vertical Farm (1), where is it used for combustion air in the boilers. Excess combustion air also cools the skin of the equipment and conditions the occupied space. The ventilated, positive pressure Tunnels allow human farmers and service personnel (19) to enter the full length of the farm without suffocation or asphyxiation by the carbon dioxide enriched, oxygen-depleted atmosphere in the greenhouse (21) above. For added safety, personnel (19) can carry supplemental breathing air tanks, or compressed breathing air can be plumbed along the Tunnels (9). Electronic breathing air monitors can be installed to alert personnel of insufficient oxygen or the presence of dangerously high carbon dioxide or ammonia. These Service Tunnels (9) double as chases for electrical, plumbing, and control cabling. The Service Tunnels (9) also afford access for personnel to the picking robots (12), the cutting robots (13), the conveyors (14), and the robot Trolleys (10). Specially made personnel lifts which can roll down the tunnels and lift personnel through small openings in the tunnel ceiling can be fitted with positive-pressure breathing tubes to allow personnel to ascend the height of the greenhouse and adjust portions of the MVFC's (11), to better service the robots (12, 13), to change light bulbs or fixtures (22), to adjust the plant height sensors (23), and to adjust the plant identification-code readers (24).

At the center-line of the Vertical Farm (1), and beneath the MVFC's (11) are larger tunnels including the Main Aqueduct (27), the Main Access Tunnel (28), and the Main Exhaust Duct (29). Along the inside of the Main Access tunnel run the Main Conveyors (14) that carry freshly harvested biomass to the very center of the Vertical Farm (1) wherein lies the Boiler and Machinery Room (31).

The Main Aqueduct (27) serves as a manifold to channel cooling water, irrigation, and condensates from the Boiler and Machinery Room (31) as they are pumped and circulated through the Aqueducts (7) in the Vertical Farm (1) and back.

The Main Access Tunnel (28) allows transportation of personnel, equipment, and large pieces of machinery for the Mill (2), Reformer (3), Boiler (4), Fermentation and Distillery (5), and the Turbine (6) to the Boiler and Machinery Room (31). The Main Access Tunnel (28) may also allow for the delivery of raw material feed-stocks as such chemicals, soils, and seeds and for the shipment of products such as food, biomass, and biofuel.

The Main Exhaust Duct (29) serves as a manifold for all process exhausts from the Boiler and Machinery Room (31) as they are routed to the Exhaust Ducts (8) for wide distribution to the Vertical Farm (1). The Main Exhaust Duct (29) also includes provisions for separation of particulate and ash, the treatment of carbon monoxide, and the treatment of NOX in the exhaust gas stream.

The Modular Vertical Farm Cells (MVFC's) (11) are continuous-loop conveyors moving potted sugar cane, corn, sorghum, switch-grass, other perennial crops, or other crops. The MVFC (11) design allows optimal, high-density growth of perennial crops and other crops, and affords optimal positioning of mature crops for automatic harvesting by robots or other mechanisms. Each potted plant rides on an individual trolley, which in turn is guided by tracks and pulled by a cable, cables, a chain, or chains. The MVFC (11) design also allows for optimal positioning of new seedlings or fresh-cut plants for re-circulation back through the said conveyor and framework. Individual plants are moved a zigzag fashion through the course of ascending and descending helical traverses for which the pitch and vertical spacing are constructed in a manner which follows the normal growth curve and provides ideal accessibility at the point of optimal harvest (11). On each MVFC (11), potted seeds, seed-pieces, seedlings, or freshly clipped perennial root masses start at the beginning of traverse A. These freshly started plants travel across traverse A, where they ascend the conveyance along the reversing traverses and helical path of column B as they mature into adolescent plants. These adolescent plants cross over along traverse C to column D, and then descend the conveyance along the reversing traverses and helical path of column D as they reach finalize maturation at position 11, where they are harvested. The freshly cut perennial sprouts anew as it repeats this path. The MVFC design has been fully described in a separate patent application by the same author of this invention.

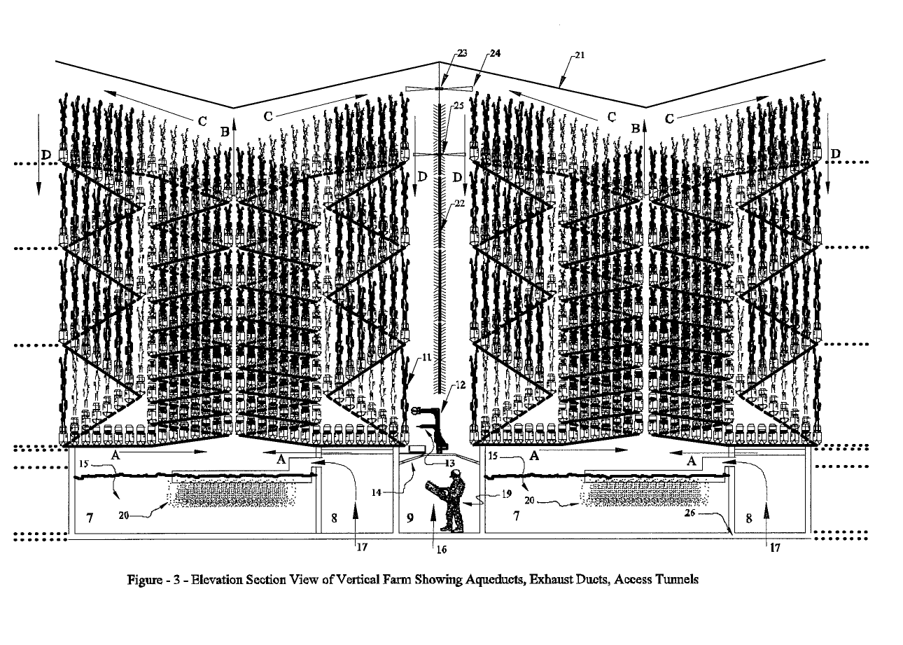

The geometry of the example MVFC's (11) as depicted in FIG. 3 has been initially chosen because of the availabilities of common construction materials and translucent plastic panels in four and eight foot lengths and in four by eight foot sheets respectively. In the depicted example, each pot and adjacent space occupies about one square-foot of plan-view space, and the depicted Cell occupies about thirty-two plan square feet. The example design allows for one plant to be harvested each day (or less than a day) in the same space that ordinarily would only produce thirty-two plants per year. Since there are 43,560 square feet per acre, 1361 such towers would be constructed per acre (FIG. 2). Each MVFC (11) alternates in one direction and then in the reverse through the zigzag, reversing traverses, forming two layers of conveyed plants. In the example, each such potted layer would have four inches clearance between its neighboring layers to allow light to filter down the tower. Other spacing can be selected to optimize light permeation through the canopy formed by MVFCs of each specific crop.

For some crops, it is desirable to control the growth of the plants to avoid the plants interfering with conveyance, competing for light, and to allow precise location of the plants. These goals can be accomplished through a pot-cap of specific geometry. For example, for sugarcane, every individual plant is cultivated in an individual pot. The pot is capped with a translucent guide that consists of an outer shell with an upper tapered shell on top and a lower tapered shell inside which serve to guide each maturing plant towards the center. The upper tapered shell creates a predictable diameter and a known position for the mature plant's stalk at some distance from the base at which a gripper mounted on the picking robot (12) or other device can be programmed to grip the stalk. A slit in the outer shell allows a cutting robot (13) to insert a cutting attachment into the guide and the lower tapered shell allows the plant to be clear-cut around a predictable path once it is fully mature while the stalk is held by the gripping robot (12). Once cut, the picking robot (12) or other device can either transport the harvested plant or can place the harvested plant on the conveyor (14) for transportation along branch and main conveyor lines (30) to a central processing area, or Boiler and Machinery Room (31). The Mill (2), Boiler (4), Reformer (3), Turbine (6), and Fermentation and Distillery (5) are all located in this central area of the Vertical Farm (1). By fixing the position for gripping and cutting, the design greatly simplifies the requirements for automation.

Each potted plant in each MVFC is irrigated through a daisy-chained system which includes individual, flexible irrigation conduits strung from pot to pot. Each conduit is connected near the top of one pot in order to capture over flow and is inserted to the soil bottom of the adjacent pot through a dip-tube. This allows a single irrigation source at the top of the Cell, at the junction of traverse C and column D (CD) to irrigate every pot in the cell to the height at which the conduits are connected. Upon filling the pot at CD to the level of the conduit connection, water over-flows to the next lower adjacent pot such that water cascades accordingly across traverse C and down column B as well as down column D and across traverse A. At the bottom, residual water can be collected in a sump or sumps and then recycled to CD. Alternately, in a similar fashion, each potted plant in the Cell will be irrigated through a daisy-chained system which includes individual, flexible irrigation conduits strung from pot to pot equipped with pressure compensating emitters at each pot. Residual water will be collected in a sump or sumps and reused through pasteurization and re-amending with liquid fertilizers so as to recycle all effluent as much as feasible.

The traverses are fastened or welded to vertical supports consisting of long, straight columns fabricated of light-gauge steel or other materials and having cross sections such as angle, channel, I, T, or flat as is indicated and appropriate to provide the main, structural, vertical support for the cell. An upper track and a lower track guide the pots and trolleys and also provide structural support by bracing the vertical supports in order to prevent buckling and allow the supports to be made from lighter, cheaper materials.

A pulley mounted on a bracket is fastened to the vertical supports located at the ends of each traverse. Through this pulley is threaded a cable or chain to which every trolley is fastened. For a traverse configured as driven, by turning the pulley one-quarter turn, the cell is indexed by one plant. The conveyor can be driven by a motor connected to a shaft of a pulley at one or more traverse-ends, or a more cost-effective approach is to have the cutting robot select a geared rotary attachment to turn the shaft.

Depending on the crop chosen, adequate overhead clearance would be needed in between traverses below and above to allow for statistical variance in plant growth. This clearance would be needed to avoid damage to the plant tops and to avoid jamming the conveyor. The design is such that sensors or other means can be employed to detect fast-growing outliers and speed up the conveyor sequencing to afford the fast-growing individuals room to grow. A plant height sensor (23) can use a beam (24) to detect, for example, when a plant has reached a particular height. Further, each individual plant in each MVFC (11) will have a unique identification code that can be read by an additional sensor (25). A overhead mobile industrial robot may be mounted on a track work in the general area of sensors (23) or (25), and this robot may be configured to take plant measurements and/or to strip necrotic lower leaves and therefore allow improved light permeation as the plant descends the canopy. When fast-growing individuals reach the harvest point, they will be identified by this code, and seed pieces will be retained for evaluation and for possible re-introduction as preferred individuals (fastest-growing, highest-yielding) in new plantings. Since sugarcane and other crops planted by seed pieces produce clones, in these cases, eventually, the whole Cell will be bred towards the highest performance cultivar and will achieve the greatest height uniformity and greatest productivity. Likewise, conveyor speeds and output will be increased and optimized.

Optimal pot size can be selected by review of the scientific literature related to root-growth and irrigation, or can be determined through empirical trials. The MVFC (11) can then be optimized for a given crop with respect to the pot size, pot spacing, structural construction, drive-horsepower and mechanical advantage, traverse pitch, irrigation, and other factors. Optimal soils will be selected based on the literature or through empirical trials.

In order to minimize the cost for each tower, the conveyance can be equipped with braking or ratcheting, but a choice can be made to omit a motor and substitute a crank or other mechanism reliant upon an external motive force. This can save the cost of motors and electrical wiring and further facilitate the mass-construction of vast arrays of MVFC's (11) incorporated into automated growing operations or farms. For sugarcane, it is estimated that a typical total weight supported by and conveyed upon the steel framework of each cell will be about 3500 pounds, including pots, soil, water, and stalks. This weight is readily supported by light-gauge formed steel members. Lightweight construction saves both fabrication costs for each Cell and also reduces loads upon structural foundations to which the Cells are anchored.

Since certain changes may be made in the foregoing disclosure without departing from the scope of the invention herein involved, it is intended that all matter contained in the above description and depicted in the accompanying drawings be construed in an illustrative and not limiting sense.

What is claimed is:

1. A Combined Vertical Farm, Biofuel, Biomass, and Electric Power Generation Process and Facility in a closed system, which incorporates the automated production of biomass and food that can be optimally transformed into biofuel and electricity as desired, which is comprised of:
a. The process flow beginning with the production of plants in vast arrays of continuous conveyance loops.
b. Optimized vertical conveyance loops of potted plants.
c. Optimize vertical conveyance loops which transport plants in the closest possible proximity to one another
d. Optimize vertical conveyance loops which approximate the same planar distribution of plants normally associated with the unit ground space while gaining a multiplicative advantage in productivity as a result of multiple tiers of plants circulating from the ground up and back down vertical towers.
e. Optimize vertical conveyance loops which can index at regular intervals such as each minute, hour, day, week, or month depending on the particular species' growth versus time, the number of total plants in the tower, the height of the tower, and the rate at which the conveyance loops are indexed.
f. A vertical growing apparatus, or “Modular Vertical Farm Cell” (MVFC) that has been fully described in a separate patent application by the same author of this invention.

2. A Modular Vertical Farm Cell or continuous-loop conveyor as claimed in claim 1 wherein said frame transports pots for plants which incorporate a guide or guides which gather and fix the positions of optimal holding and cutting areas for said plants. Said holding and cutting areas are thereby facilitated for automated holding, harvesting, and picking.

3. A Modular Vertical Farm Cell or continuous-loop conveyor as claimed in claim 1 comprised to facilitate optimal plant breeding by fixing the positions of said plants at all stages of maturity, thereby allowing said plants to be automatically measured and compared. Further said fixing of individual positions allows automated determinations to take place as to which plants exhibit the best genetic characteristics and the subsequent automatic and preferential selection of said optimal individuals for subsequent breeding and planting.

4. A Modular Vertical Farm Cell or continuous-loop conveyor as claimed in claim 1 comprised to allow automatic operation such that the entire apparatus can be placed in conditions such as a controlled environment enclosure or greenhouse the conditions of which might be ideal for said plants but which humans cannot withstand such as but not limited to elevated carbon-dioxide, depleted oxygen, enhanced lighting in excess of natural sunlight, elevated temperatures, elevated humidity, dispersions of deliberately chosen pollutants, and the additions of favorable chemicals for fertilization, anti-microbial, and herbicidal purposes.

5. A Modular Vertical Farm Cell or continuous-loop conveyor as claimed in claim 1 comprised to allow automatic operation in order to achieve the fastest possible conveyance from harvest to use and thereby retain the freshest characteristics at the point-of-use.

6. A Modular Vertical Farm Cell or continuous-loop conveyor as claimed in claim 1 which effectively multiplies the quantity of plants cultivated per unit land-area by creating an array of plants on said framework which towers in vertical columns.

7. The system of claim 6 which allows a mass-arrayed farm comprised of said Modular Vertical Farm Cells or continuous-loop conveyors as claimed in claim 1 to be arranged in close proximity to apparatus such as power generation facilities, distillation facilities, milling operations, and other processing facilities in order to benefit from sources of waste heat, waste carbon dioxide, waste steam, waste water, and excess power.

8. The system of claim 6 which allows the growing day and growing season for said plants to be extended or multiplied.

9. The system of claim 1 which allows the adaptation of the design to any perennial crop or other crops.

10. The system of claim 1 which allows just-in-time harvesting of said plants.

11. The system of claim 1 which allows the entire apparatus to be constructed at a low enough cost to be mass-produced and mass-arrayed into an extensive farming operation.

12. A system of cultivation where crops may be harvested automatically which is comprised of:
a. Cultivation of crops in vast arrays of MVFC's or indexing vertical growing apparatuses where the plants are harvested at fixed locations by conventional industrial robots.
b. Movement of the robots from MVFC to MVFC on automated rail or cable-guided trolleys for sequential harvesting of each MVFC.
c. Transportation of harvested foods and biomass on networks of conveyors to a central location for milling, fermentation, and distillation into biofuels.

13. A system of processing waste products from in-situ farming, milling, fermentation, and distillation, comprised generally of leftover biomass including:
a. Reforming into more biofuel.
b. Burning in a Rankine power cycle to produce electricity
c. Burial or conversion to durable consumer goods to the end of sequestering carbon from the atmosphere and the accompanying end of reversing or controlling global warming.
d. Burial for the purposes of providing high-quality topsoil and landfill.
e. Processing for exploitation of other by products.

14. A system of processing the waste products of the combustion processes (reforming, electric generation) comprised generally of heat, moisture, carbon dioxide, mineral ash, and reactive nitrogen by recycling these back to the Vertical Farm. The compact nature of the Vertical Farming operation allows even distribution of these waste products, with minimal losses.

15. A fully automated and enclosed process which can be operated in conditions inhospitable to human occupancy and yet remarkably optimal for the cultivation of plants that has the following advantages:
a. Greatly enhanced growing characteristics as a result of elevated carbon dioxide.
b. Enhanced growing characteristics as a result of decreased oxygen.
c. Enhanced growing characteristics as a result supplemental light.
d. Enhanced growing characteristics as a result extended growing day.
e. Enhanced growing characteristics as a result elevated temperature coinciding with elevated moisture and carbon dioxide.
f. Enhanced growing characteristics as a result of optimal soil conditions.
g. An operation inhospitable to pests and some microbes, lending to reductions or eliminations in required pesticides and fungicides and, in some cases, the production of organic food, fuel, power, and biomass.
h. Automation also provides the opportunity for artificial intelligence-based selection of highest-yielding individuals for re-planting, leading to generation after generation of improvement.
i. An enclosed operation, in a greenhouse environment, that affords protection from adverse weather and environmental conditions making the production secure and predictable. An enclosed operation, in a greenhouse environment, that affords the optimal distribution of waste heat, moisture, carbon dioxide, mineral ash, and reactive nitrogen and the coinciding recovery of the maximum amount of said waste products.

16. A Modular Vertical Farm Cell or continuous-loop conveyor moving and cultivating potted sugar cane, corn, sorghum, switch-grass or other crops on a towering framework comprising of:
a. A framework;
b. Optimal, high-density growth of crops arrayed along reversing traverses and circulating through stages of maturation upon the framework.
c. Optimal positioning of mature crops at an accessible point on the framework for automatic harvesting by robots or other mechanisms.
d. Optimal positioning of new seedlings or fresh-cut perennials for re-circulation back through the said conveyor and framework.
e. A conveyor configuration in which individual plants are moved a zigzag fashion through the course of ascending and descending helical traverses upon the framework for which the pitch of and vertical spacing between traverses are constructed in a manner which follows the normal growth curve and affords ideal accessibility at the point of optimal harvest.
f. A conveyor configuration in which potted seeds, seed-pieces, seedlings, or freshly clipped perennial root masses start on the framework at the beginning of a lower, horizontal traverse, at a point of ideal accessibility. Freshly initiated plants travel across the lower, horizontal traverse, where they ascend the conveyance along the reversing traverses and helical path of a vertical column on the framework as they mature into adolescent plants. The adolescent plants cross over along an upper, horizontal traverse on the framework to another column on the framework, where they descend the conveyance along the reversing traverses and helical path of said second column until they reach finalize maturation at the starting position, where they are harvested. The freshly cut plants are then replaced if aged or recycled through the same path described if said plants continue to be vital after harvest.

17. The system of claim 16 where said plants arranged with optimum density by spacing of conveyor traverses such that the size of plants at each stage of maturity is most precisely afforded.

18. The system of claim 16 where said plants, while optimally spaced to minimize overall space are yet spaced such that natural and artificial light sources filter throughout the conveyance and such that statistical variations in plant size are afforded by extra space allowance.
